(19) United States
(12) Patent Application Publication
(10) Pub. No.: US 2019/0320039 A1
(43) Pub. Date: Oct. 17, 2019

(54) SYSTEMS AND METHODS FOR USE IN PROVIDING DIGITAL IDENTITIES

(71) Applicant: MASTERCARD INTERNATIONAL INCORPORATED, Purchase, NY (US)

(72) Inventor: Ashfaq Kamal, Stamford, CT (US)

(21) Appl. No.: 16/382,521

(22) Filed: Apr. 12, 2019

Related U.S. Application Data
(60) Provisional application No. 62/657,276, filed on Apr. 13, 2018.

(51) Int. Cl. H04L 29/08; H04L 29/06

(52) U.S. Cl. CPC H04L 67/306; H04L 63/0861

(57) ABSTRACT

Systems, devices and methods are described herein for providing digital identities. One exemplary device includes a portable communication device having non-transitory computer executable native code, which configures the portable communication device to facilitate storing of a digital ID token for a user in memory of the portable communication device, as part of a setup procedure of the portable communication device associated with an initial startup of the portable communication device by the user or a startup of the device after a factory reset, whereby the digital ID token is provisioned to the portable communication device, either in dependence of or apart from any application downloaded to the communication device after the setup procedure.

### CROSS-REFERENCE TO RELATED APPLICATION

This application claims the benefit of, and priority to, U.S. Provisional Application No. 62/657,276 filed on Apr. 13, 2018. The entire disclosure of the above-referenced application is incorporated herein by reference.

### FIELD

The present disclosure is generally directed to systems and methods for use in providing digital identities, and in particular, to systems and methods for use in providing digital identity services in connection with communication devices, and, specifically, in connection with setup procedures associated with the communication devices.

### BACKGROUND

This section provides background information related to the present disclosure which is not necessarily prior art.

People are known to be associated with identities. The identities are often verified, by relying parties, through one or more physical documents (e.g., driver's licenses, government issued cards or other documents (e.g., birth certificates, etc.), utility bills, etc.). In connection therewith, or alternatively, digital identities may be used to evidence the identity of a user. Separately, users are known to be associated with and/or to own smartphones, tablets, etc., broadly, portable communication devices, which the users may carry with them from place to place. The communication devices are known to include applications, installed by the users, which permit the communication devices to offer services to the users (e.g., social network services, entertainment services, etc.). Apart from the applications, the communication devices also generally include operating systems (e.g., an Android® operating system, an iOS® operating system, etc.), which manage the operation of the communication devices and enable the installation and use of the applications. Moreover, when the communication devices are powered on, for the first time by users, the communication devices are known to follow setup procedures, which prompt the users to provide select preferences, to set up certain features (e.g., login credentials, etc.), etc.

### DRAWINGS

The drawings described herein are for illustrative purposes only of selected embodiments and not all possible implementations, and are not intended to limit the scope of the present disclosure.

FIG. 1 is an exemplary system of the present disclosure suitable for use in providing digital identities for users at communication devices;

FIG. 2 is a block diagram of a computing device that may be used in the exemplary system of FIG. 1; and

FIG. 3 includes a flow diagram for an exemplary method, which may be implemented in connection with the system of FIG. 1, for providing a digital identity, through use of a digital identity token at a communication device, in connection with a setup procedure associated with the communication device.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Users rely on their identities for a variety of reasons, including, for example, to gain entry to locations and/or to certain modes of transportation (e.g., airplanes, etc.), to open accounts (e.g., credit accounts, etc.), etc. In such cases, users often present physical documents to evidence their identities, whereby relying parties then evaluate the physical documents and permit the users to continue, as appropriate. What's more, digital identity applications may also be used, by the users, to digitize their identities and facilitate more efficient verification of the users (in lieu of providing the physical documents). The provisioning of identities to the applications, however, may be cumbersome and the presentation of the identities to relying parties may be limited by the applications, etc.

Uniquely, the systems and methods herein permit a user to generally provision his/her identity to a portable communication device (e.g., a smartphone, a tablet, etc.) during a setup procedure for the device (e.g., when the user newly acquires the device, when the user resets the device, etc.). In particular, the communication device includes firmware executed by the device, and an operating system that executes software included in the device (broadly referred to as native code). In connection therewith, the identity functionality is bound into the native code, i.e., the firmware and/or software (in whole or in part), such that the digital identity setup for the user becomes part of the setup procedure for the device. Thereafter, when the user powers on the device, for the first time, for example, the user is prompted to provision a digital identity thereto. The commination device and the user then interact to capture images of physical documents associated with the identity of the user, and a biometric associated with the user, which in turn are provided to an identity verifier (e.g., a government entity, etc.), through an identity provider (IDP), for verification. Once verified, an identity token is compiled for the user, by the IDP, for example, and provisioned to the user's device. And, the identity token is optionally encrypted, and then stored for later use by the user for showing his/her identity. In this manner, the digital identity procedure is embedded in the setup procedure of the communication device, thereby improving the likelihood that the user will engage in using such digital identity, and thereby also providing a digital identity and/or platform in the communication device that is universal and/or common to applications installed in the communication device.

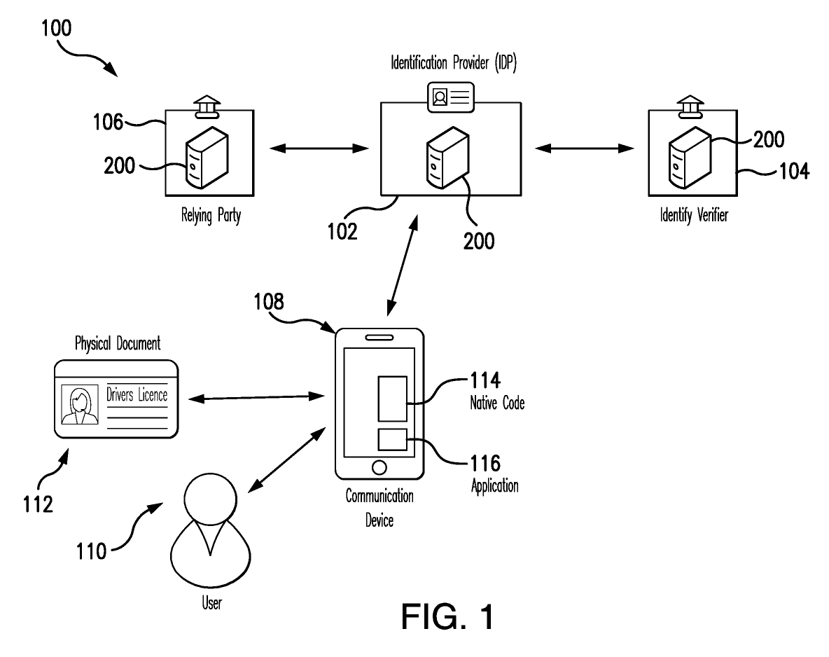

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, relationships between users, identification providers, and identity verifiers; types of devices utilized with digital identities; relationships between users and relying parties; types of relying parties; privacy requirements; etc.

The illustrated system 100 generally includes an identification provider (IDP) 102, an identity verifier 104, a relying party 106, and a communication device 108 associated with a user 110, each of which is coupled to (and is in communication with) one or more networks. The network(s) is/are indicated generally by arrowed lines in FIG. 1, and may include one or more of, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

The IDP 102 of the system 100 generally is associated with providing digital identity services to users (e.g., the user 110, etc.) and to relying parties (e.g., the relying party 106, etc.). In FIG. 1, the IDP 102 is illustrated as a standalone service and/or device of the system 100. However, the IDP 102 may additionally, or alternatively, be incorporated in whole or in part with another party in the system 100, such as, for example, a payment network or a banking institution, etc. Specifically, for example, the IDP 102 may be incorporated into the Mastercard® payment network and configured to operate as described herein to provide corresponding services to users via and/or in association with the Mastercard® payment network. In this exemplary embodiment, the IDP 102 is configured to expose an application programming interface (API) or multiple APIs to interact with the relying party 106, the identity verifier 104, and/or the communication device 108, etc., as described herein to provide the desired digital identity services.

The identity verifier 104 in the system 100 includes an entity that knows the identity of the user 110 (and other users), for example, based on records associated with the user 110, etc. In this exemplary embodiment, the identity verifier 104 includes a government entity, such as a state department of motor vehicles (DMV), or a customs and border protection agency, either of which possesses a record associated with each of multiple users (including the user 110), where the record includes (at the least) a biometric associated with the particular user. For example, the DMV has a record, by driver's license number, which includes a facial image of each user with a driver's license issued thereby. It should be appreciated that other entities, including, for example, financial institutions, utility providers, medical services entities, telecommunication providers, etc. (and more generally, any entity in possession of a biometric, which is verified to a particular user) may also be identity verifiers in other system embodiments (with each potentially including different attributes of a user's identity).

And, the relying party 106 may include any entity that interacts with the user 110 and/or relies on the asserted identity of the user 110 to provide a desired service, etc. For example, the relying party may include a financial institution (e.g., a bank, an investment broker, etc.), a utility provider, a telecommunication provider, a medical service provider, a potential employer, etc. with which the user 110 may interact for the desired service (and to which the user 110 may be required to verity his/her identity in order to receive the desired service).

In this exemplary embodiment, the communication device 108 associated with the user 110 includes a portable communication device, such as, for example, a smartphone, a tablet, etc. The communication device 108 is generally owned by, issued to, and/or otherwise associated with the user 110. Apart from the communication device 108, the user 110 is also associated with a physical document 112 (shown as a driver's license issued to the user 110 by a state, regional, or federal government). It should be appreciated that additional and/or other physical documents for the user 110 may be included in the system 100, such as, for example, a passport, a government issued ID, a social security card, a health insurance card, a bank statement, an employee ID, a library card, a utility bill, etc.

With continued reference to FIG. 1, the communication device 108, as illustrated, includes a native code 114, which is, generally, firmware and/or software native to the communication device 108 when initially delivered to the user 110. For example, the native code 114 may include one or more of firmware that provides low-level instructions to the device 108 (e.g., boot processes, etc.), an operating system (e.g., an Android® operating system, an iOS® operating system, etc.) that supports basic functions of the device 108, and software that is executed, by the operating system, to provide broader functions of the device 108. In this exemplary embodiment, the native code 114 includes at least a startup or a setup script, etc., and configures the communication device 108 to follow a setup procedure (or activation procedure) (e.g., upon a first power-up of the device 108, upon a reset of the device 108 to factory default settings, etc.), whereby certain data associated with the user 110 is solicited (e.g., an email address, a name, user preferences, etc.) and/or certain features of the device 108 are setup (e.g., a time zone, login credentials, user preferences, etc.). This is described in more detail below. That said, and to be clear, the native code 114 is native to the communication device 108 (upon receipt of the device 108 by the user 110), and thus, is not generally downloaded and/or downloadable to the communication device 108 by the user 110 (but is included “out of the box”) (i.e., the native code is different from and is not an application that may be subsequently installed at the device 108).

Conversely, in addition to the native code 114, the user 110 is permitted to download and install one or more mobile applications to the communication device 108, after the setup procedure, such as mobile application 116. The mobile application 116 may include a financial application, an entertainment application, a social network application or any other application, which the user 110 expects and/or desires to utilize. In connection therewith, and as used herein, the mobile application 116 installed at the user's communication device 108 is provided by the relying party 106 and relies on an identity of the user 110, as is described in more detail below.

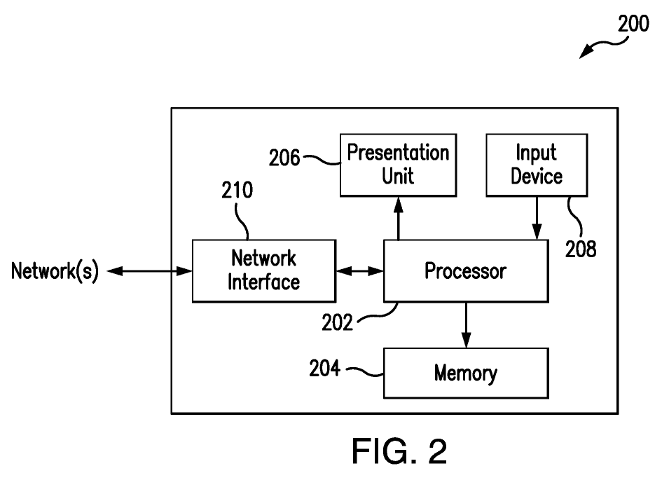

FIG. 2 illustrates an exemplary computing device 200 that can be used in the system 100 of FIG. 1. The computing device 200 may include, for example, one or more servers, workstations, personal computers, laptops, tablets, smartphones, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the IDP 102, the identity verifier 104, and the relying party 106 is illustrated as including, or being implemented in, computing device 200, coupled to (and in communication with) one or more networks. In addition, the communication device 108 should be understood to be a computing device generally consistent with computing device 200. However, it should be appreciated that the system 100 is not limited to the computing device 200, as described below, as different computing devices and/or arrangements of computing devices may be used in other embodiments.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, identity (or ID) tokens, keys, biometric data, biometric references, identity records including ID data (e.g., attributes, etc.), document images, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. For example, such instructions may be included in the native code 114 and/or the application 116 (for defining operations of the computing device 200 consistent with the description herein), etc. Such instructions often improve the efficiencies and/or performance of the processor 202 and/or other computer system components configured to perform one or more of the various operations herein. It should be appreciated that the memory 204 may include a variety of different memories, each implemented in one or more of the functions or processes described herein.

The computing device 200 also includes a presentation unit 206 that is coupled to (and is in communication with) the processor 202 (however, it should be appreciated that the computing device 200 could include output devices other than the presentation unit 206, etc.). The presentation unit 206 outputs information (e.g., prompts to opt into provisioning a digital identity, prompts to present a document or biometric, etc.), visually or audibly, for example, to a user of the computing device 200 (e.g., user 110 associated with the communication device 108, etc.), etc. And various interfaces (e.g., as defined by the native code 114, etc.) (e.g., instructions to scan a physical document, or present a biometric, or opt into provisioning a digital identity, etc.) may be displayed at computing device 200, and in particular at presentation unit 206, to display certain information in connection therewith. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) of the computing device 200 such as, for example, images of documents, etc., in response to prompts from the native code 114, as further described below. The input device 208 may include a single input device or multiple input devices. What's more, the input device 208 is coupled to (and is in communication with) the processor 202 and may include, for example, one or more of a keyboard, a pointing device, a camera, a touch sensitive panel (e.g., a touch pad or a touch screen, etc.), another computing device, and/or an audio input device. In various exemplary embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a Bluetoot™ adapter, an NFC adapter, etc.), a mobile network adapter, or other device capable of communicating to one or more different ones of the networks herein and/or with other devices described herein. In some exemplary embodiments, the computing device 200 may include the processor 202 and one or more network interfaces incorporated into or with the processor 202.

Referring again to FIG. 1, when the user 110 purchases the communication device 108 or otherwise receives the device 108 for the first time (before the application 116 is downloaded or installed), the communication device 108 is configured in a factory default or “out of the box” condition. Upon power up by the user 110, or in connection with the device 108 being issued or otherwise associated with the user 110, the communication device 108 (e.g., the processor 202 thereof, etc.) is configured, by the native code 114 (e.g., as stored in the memory 204 of the device 108, etc.), to perform a setup procedure. While the setup procedure may include several parts (e.g., soliciting an email address or profile for the user 110, identifying a wireless network, registering the device 108 to a mobile network and/or mobile phone number, etc.), at one part, the communication device 108 is configured, by the native code 114, to offer the option for the user 110 to create a digital identity to be provisioned to the communication device 108. In general, this occurs before the user 110 is able to otherwise use the device 108 for its intended purpose (e.g., as a phone to make a call, etc.) and prior to download and installation of any application (including the application 116), etc.

When the user 110 opts into the provisioning of the digital identity, the communication device 108 is configured, by the native code 114, to instruct the user 110 to scan an image of a physical document associated with the user 110, such as the physical document 112 (e.g., the user's driver's license, etc.). In response to one or more inputs from the user 110, the communication device 108 is configured, by the native code 114, to capture an image of the physical document 112 and also, optionally, an image of the user 110 (e.g., a facial image, a selfie, etc.) or other biometric of the user 110 (e.g., an iris scan, a fingerprint, a palm print, etc.) and store the same as a template (e.g., a biometric template, etc.). Apart from the capture of the image, via a camera input device of the communication device 108, it is contemplated that the communication device 108 may be configured to otherwise interact with the physical document 112 (depending on the particular type of the physical document 112), such as, for example, through an NFC interaction with a security chip of the document 112 (e.g., such as a security chip of a passport document (e.g., a mutually authenticated reading of the passport, etc.), etc.), whereby an image may then be generated for the document 112. The communication device 108 is then configured, by the native code 114, to securely transmit the captured image(s) (or template(s) for the image(s)) to the IDP 102 associated with providing the digital identity to the user 110. It should be appreciated that the native code 114 may include, for example, identifying information associated with the IDP 102 (e.g., email address, API, etc.) to thereby enable the captured image(s) or template(s) for the image(s) to be transmitted to the IDP 102. In turn, the IDP 102 is configured to pass the image(s) to the identity verifier 104, for example, associated with the document 112, etc. (where different identity verifiers may be associated with different documents provided by the user 110 and, depending thereon, may also or alternatively be contacted by the IDP 102).

In response, the identity verifier 104 is configured to verify the identity of the user 110 and to also verify the biometric (e.g., the image of the user 110, etc.) provided from the communication device 108. In particular, for example, where the identity verifier 104 is the DMV, the identity verifier 104 is configured to verify the image of the physical document 112 (i.e., the driver's license, etc.) against its records for the driver's license (e.g., content therein, etc.) and/or to verify the selfie of the user 110 (or biometric template therefor) against an image of the user 110 previously captured by the DMV, for example, when the driver's license was issued (and stored in an identity record in memory by the DMV). It should be appreciated that the same or similar verifications, by the identity verifier 104, may be completed on other types of physical documents and/or biometrics received from the communication device 108. And, once verified, the identity verifier 104 is configured to provide an assertion for the image(s) and the user 110 back to the IDP 102.

In turn, the IDP 102 is configured to compile a digital identity (or ID) token for the user 110, which securely binds data therein, and stores the digital ID token (or a version thereof) in memory (e.g., the memory 204, etc.) in the IDP 102. In this exemplary embodiment, the ID token includes and/or binds the name of the user 110, contact information for the user 110, a device ID for the communication device 108 (generally linking the communication device 108 to the ID token, for example, when the user 110 subsequently requests use of the ID token, etc.), the image of the physical document 112 (or template thereof), one or more attributes of the user's identity, and/or the captured biometric of the user 110 (as a biometric template), etc. It should be appreciated that other suitable and/or desired data may be included and/or bound within the ID token in other system embodiments. Further, the IDP 102 is configured to, optionally, sign the ID token (e.g., with a key, etc.), and then to transmit the ID token to the communication device 108. Upon receipt, the communication device 108 is configured to encrypt the ID token and to store the encrypted ID token in memory (e.g., the memory 204, etc.) in a TEE or trusted execution environment therein, whereby the digital identity (i.e., the ID token) is provisioned to the communication device 108.

The setup procedure for the communication device 108 is then, or later, completed by the user 110, and the communication device 108 is configured to continue to normal operation. With that said, while in the above description the user 110 is prompted to provision the ID token during the setup of the communication device 108, it should be understood that, where the user 110 opts not to provision the ID token during setup, a further option may be included in the settings associated with the communication device 108, as provided by the native code 114, to permit the user 110 to provision the ID token to the communication device 108 at some time after the setup procedure is complete.

Thereafter in the system 100, the communication device 108 is configured, by the native code 114 or otherwise, to perform an integrity check on the digital ID token. Specifically, the integrity check of the ID token may be performed at one or more regular or irregular intervals (e.g., a defined interval of 1 hour, 3 hours, 6 hours, daily, weekly, monthly, etc.), where the integrity check is based on, for example, a holding pattern and/or an authentication history of the user 110 at the communication device 108. For example, the communication device 108 may be configured to determine a device holding pattern of the user's right and/or left hand (e.g., based on sensor(s) included in the communication device 108, etc.) (e.g., from the time of setup or activation, etc.), an authentication pattern (or trend) and/or timing (e.g., on even weekday mornings at 6:00 AM, never between 10-11:30 AM, a repeated retina scan, a repeated facial image scan, etc.)(broadly, an authentication history), and/or a user profile of the communication device 108 (e.g., based on the user's repeated and/or normal uses of the communication device 108, etc.). In any of the above scenarios, or even in others, the integrity check may serve to identify when a different user is using the communication device 108 (different than the user 110) and/or when malicious applications/software has been installed, etc. And, in connection therewith, the communication device 108 may be configured to determine when use of the device 108 deviates from the normal use determined/identified by the device 108 (e.g., a different holding pattern and/or use profile of the user 110, etc.) and to trigger a flag and/or integrity check on the ID token, whereby the user's identity may need to be further verified by one or more techniques.

Further in the system 100, after (or when) the user 110 downloads and installs the mobile application 116 at the communication device 108, the user 110 launches the application 116. In response, the communication device 108 is configured, by the application 116, to contact the IDP 102 to determine whether the device ID for the communication device 108 is provisioned through the IDP 102 (e.g., through an API call to the IDP 102, etc.) (since the application 116 herein generally relies on the identity of the user 110 being accurate and/or verified). When the device ID is known to the IDP 102 (as being part of an ID token), the IDP 102 is configured to notify the application 116. The communication device 108 is then configured, by the application 116, to prompt the user 110 to create an account via the data stored in the ID token included in the communication device 108. When the user 110 consents, the communication device 108 is configured, by the application 116 and/or the native code 114, to capture a biometric of the user 110. Then, when the consent is provided and the biometric is verified, for example, by the communication device 108 (against a biometric reference and/or biometric template and/or other template in the ID token for the user 110), the communication device 108 is configured, by the application 116, to provide identity data and/or the ID token, for the user 110, to the relying party 106 (as the backend of the application 116), whereby an account for the user 110 is created by the relying party 106, whereby the relying party 106 may access the digital identity of the user 110 (e.g., via an API call to the IDP 102 (including the ID token), etc.), and whereby the user 110 is permitted to login to the application 116 via the biometric (i.e., through authentication to the ID token). In this manner, the ID token is generally used as the basis for creating the user's account at the relying party 106, through the application 116 (e.g., without specifically providing further documents to the relying party evidencing the user's identity, etc.).

Similarly, when the user 110 already has an account for the application 116 (e.g., initiated on another device, or the ID token is provisioned after setup of the communication device 108 and after installation of the application 116, etc.), the communication device 108 is configured, by the application 116, to seek login of the user 110 through existing credentials and then to contact the IDP 102 to determine whether the device ID for the communication device 108 is provisioned through the IDP 102 (e.g., through an API call to the IDP 102, etc.). When provisioned, the communication device 108 is configured, by the application 116, to request the user 110 to bind the ID token to the account for the application 116, to thereby provide verified data to the backend of the application 116 and to login through the ID token for future access. When the user 110 consents and provides a biometric (consistent with the biometric (or other template) included in the ID token), the communication device 108 is configured, by the native code 114 and/or the application 116, to capture and verify the biometric with the ID token, and then to provide the signed ID token to the relying party 106 (as part of binding it to the account for the application 116). Upon receipt of the ID token, the relying party 106 is configured to validate the ID token based on a key included in a software development kit (SDK) (or accessible by the SDK) and provided by the IDP 102 and utilized by the relying party 106. Once verified, the relying party 106 updates the account data based on the data included in and/or associated with the ID token. What's more, the account for the user 110 at the application 116 is enabled for login, at the communication device 108, through authentication to the ID token in the communication device 108. In this manner, the ID token is generally used as the basis for accessing and updating the user's account at the relying party 106, through the application 116 (e.g., again, without specifically providing further documents to the relying party evidencing the user's identity; etc.).

In another aspect, the user 110 is permitted to change data included in the ID token or add verified data (i.e., data suitable to be verified) or other data (e.g., holding patterns, authentication history, etc.) to the digital ID token stored in the communication device 108. Specifically, the communication device 108 is configured, by the native code 114, to authenticate the user 110 based on a biometric provided by the user and captured by the communication device 108, and also the ID token (e.g., where the captured biometric may be compared, by the communication device 108, to a biometric in the ID token; etc.). Once authenticated, the communication device 108 is configured, by the native code 114, to prompt the user 110 to enter and/or change data included in the ID token and to transmit updated data to the identity verifier 104, via the IDP 102. The identity verifier 104 is configured to update the data included in its identity record for the user 110 and/or to verify the updated data (when the identity verifier 104 already knows about the updated data). Regardless, an assertion, similar to the above, is returned, from the identity verifier 104, to the IDP 102. In turn, the IDP 102 compiles and transmits a new ID token to the communication device 108 (in the manner described above). The communication device 108 is configured, by the native code 114, to store the new ID token (in place of the prior ID token) as described above (for subsequent use in place of the prior ID token).

In a further aspect, when the user 110 accesses a website or webpage (as hosted by the relying party 106), the relying party 106 is configured to determine whether the device ID, for the communication device 108, is associated with an ID token. If it is, the relying party 106 is configured to prompt the user 110 to enter a mobile phone number or other identifier associated with the communication device 108 (to which the ID token is provisioned). In response, the relying party 106 is configured to contact the IDP 102, which, in turn, is configured to transmit a notification (e.g., a push notification, etc.) to the communication device 108. Based on the notification, the communication device 108 is configured, by the native code 114, to authenticate the user 110 (as described above, for example, through use of the ID token) and to transmit the ID token (either directly or via the IDP 102) to the relying party 106. The ID token is signed by the IDP 102, which permits the relying party 106 to verify the ID token again through the SDK provided by the IDP 102 and utilized by the relying party 106.

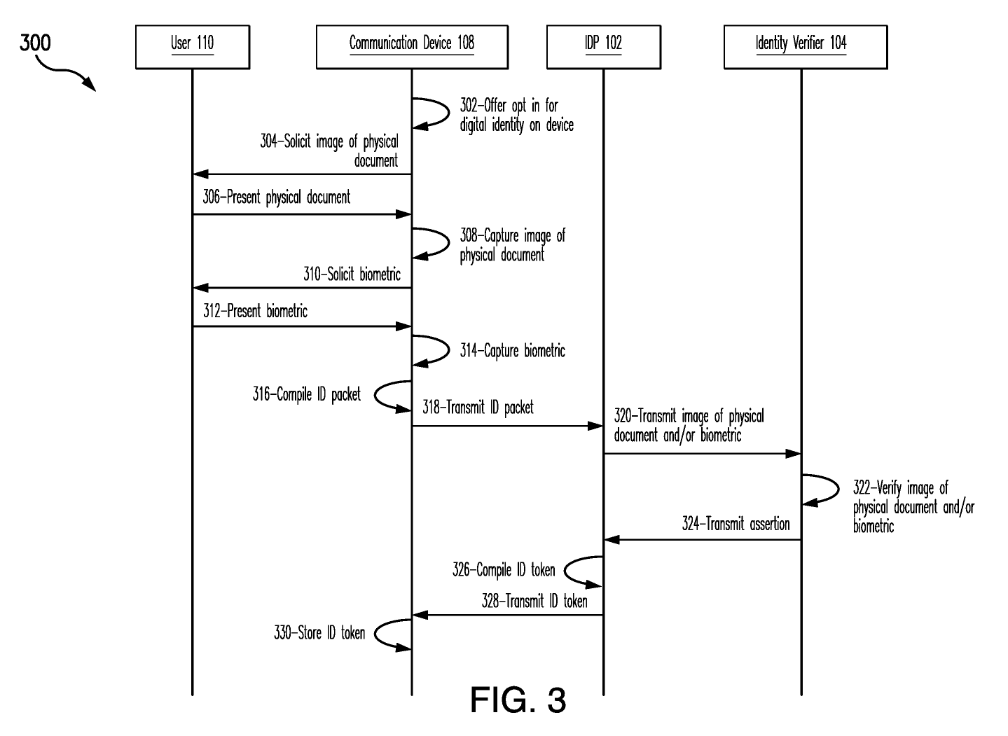

FIG. 3 illustrates an exemplary method 300 for providing a digital identity, through use of a digital ID token at a communication device, in connection with a setup procedure associated with the communication device. The exemplary method 300 is described as implemented in the communication device 108 of the system 100 (inclusive of the native code 114 and the application 116), in conjunction with the IDP 102 and the identity verifier 104. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the exemplary method 300.

In the method 300, the user 110 purchases or is otherwise assigned and/or issued the communication device 108. Thereafter, the user 110 powers on the communication device 108, causing an initial startup of the communication device 108. Alternatively, the communication device 108 may be returned to a factory default setting, through a factory reset command from the user 110 or other person (e.g., a technician, technical support person, etc.), whereupon the user 110 then causes the initial startup of the communication device 108 after the factory reset command. In either instance, or in others, the communication device 108 executes the native code 114 in the communication device 108, to, among other things, initiate a setup procedure for the communication device 108. As part of the setup procedure for the communication device 108, the communication device 108 (as directed by the native code 114) then offers an option for the user 110 to opt into a digital identity feature/service on the communication device 108, at 302. For example, the communication device 108 may invite the user 110 to bind his or her identity to a digital identity to be stored and/or included in the communication device 108, to subsequently evidence the identity of the user 110 to one or more relying parties (e.g., the relying party 106, etc.) when desired or necessary.

When the user 110 opts in (e.g., by selecting “OK” or “Yes”, etc.) and potentially also consents to terms and conditions of the digital identity (e.g., as presented to the user 110 through the communication device 108 as a user agreement, etc.), the communication device 108 solicits, at 304, an image of the physical document 112 associated with the user 110 as a basis to confirm the user's identity. In response, the user 110 presents the psychical document 112 to the communication device 108, and in particular, to a camera input device (e.g., input device 208, etc.), at 306. The communication device (as directed by the native code 114) then captures, at 308, an image of the physical document 112. With that said, it should be appreciated that the communication device 108 may otherwise interact with the physical document 112 to capture information therefrom, including, for example, via a network connection with a security chip or other processor embedded in the physical document 112 (e.g., via network interface 210, etc.), etc.

Next in the method 300, the communication device 108 solicits, at 310, a biometric from the user 110, such as, for example, presentment of the user's face (e.g., via a selfie image of the user 110, etc.), a fingerprint, or an iris, etc. of the user 110. In response, the user 110 presents the appropriate biometric to the communication device 108, at 312, for example, the user's face to the camera input device. And, in turn, the communication device 108 (as directed by the native code 114) captures, at 314, the biometric, for example, as an image, as a biometric template, or otherwise.

Once the image of the physical document 112 and the user's biometric are captured, the communication device 108 (as directed by the native code 114) compiles, at 316, an identity packet for the user 110, which includes, without limitation, the captured image of the physical document 112 (or other data from the physical document 112), the captured biometric (in raw form or as a biometric template), details of the user's identity (e.g., a name, a mailing address, a phone number, a date of birth, a government ID number, etc.), one or more attributes of the user 110 (e.g., height, eye color, weight, etc.), and a device ID for the communication device 108, etc. (e.g., based on information in the physical document 112, based on responses provided by the user 110 during setup of the communication device 108, etc.) The identity (or ID) packet is then transmitted, at 318, from the communication device 108 to the IDP 102. And, in turn, the IDP 102 transmits the identity packet, or part thereof, to the identity verifier 104, at 320 (e.g., the image of the physical document 112, the captured biometric for the user 110, etc.). It should be appreciated that the IDP 102 may transmit the entire identity packet to the identity verifier 104, or the IDP 102 may only provide the image of the physical document 112 and/or the captured biometric to the identity verifier 104 (generally along with some identifier of the user 110 so that the identity verifier 104 is able to locate a user record associated with the user 110).

Thereafter, the identity verifier 104 verifies the image of the physical document 112 and/or the received biometric, at 322. In doing so, the identity verifier 104 retrieves a user profile associated with the user 110, which includes biometric data for the user 110. For example, when the identity verifier 104 includes a DMV (and already has a profile for the user 110 based on prior interactions of the user 110 therewith, for example, to obtain a driver's license), the identity verifier 104 may retrieve an image of the driver's license of the user 110 for comparison to the captured image of the physical document 112 (which, in this example, is also a driver's license) to verify that the physical document 112 is specific to the user 110. The comparison may include the entire image of the physical document 112, or only the facial image (or other biometric) contained in the physical document 112. The identity verifier 104 further verifies a match between the received biometric (when received) and a reference biometric included in a user profile for the user 110 and/or in the retrieved image of the driver's license (e.g., based on a biometric confidence score exceeding a value (e.g., False Match Rate (FMR) and/or False non-match rate (FNMR), or other suitable metric, etc.)), thereby also ensuring the biometric (e.g., the selfie of the user 110 in the above example, etc.) is specific to the user 110 and that the physical document 112 is specific to the user 110 (i.e., to prevent someone other than the user 110, who has the user's driver's license, from registering the user's digital identity with a different biometric).

Once the received data is verified, the identity verifier 104 issues and transmits, at 324, an assertion indicative of verification of the image of the physical document 112 and/or the biometric, to the IDP 102. The assertion often will be signed by the identity verifier 104 and specifically attributed to the identity verifier 104 (or an identifier associated therewith). In at least one embodiment, the identity packet compiled by the communication device 108 is transmitted directly by the communication device 108 to the identity verifier 104, and not through the IDP 102. In such an instance, the assertion is transmitted, by the identity verifier 104 directly back to the communication device 108, which then provides the assertion (as signed by the identity verifier 104) to the IDP 102, along with the identity packet or parts thereof (e.g., with sufficient information to compile the digital ID token, as described below).

When the IDP 102 receives the assertion (either from the identity verifier 104 or the communication device 108), it compiles, at 326, a digital ID token for the user 110 and transmits the digital ID token to the communication device 108, at 328. In this example, the digital ID token includes the device ID for the communication device 108, the assertion from the identity verifier 104 (and/or identifier associated with the identity verifier 104 and a time and date of the assertion), the image of the physical document 112 (and/or biometric data included in the captured image of the physical document 112), one or more attributes of the user 110, the captured biometric of the user 110, and identity data for the user 110, etc. Generally, the digital ID token is also signed by the IDP 102 prior to being transmitted to the communication device 108.

Upon receipt of the digital ID token, the communication device 108 (as directed by the native code 114) encrypts the digital ID token (optionally) and stores, at 330, the digital ID token (or encrypted digital ID token) in memory (e.g., the memory 204, etc.) in a TEE or trusted execution environment therein. As stored, the ID token is indexed to the user 110, and specifically, the biometric presented by the user 110 above. In this manner, when another user authenticates to the communication device 108, he/she is not provided access to the ID token, because the biometric will not match. Only the user 110, thus, is permitted, by the indexing of the ID token, to access and share the digital ID token (thereby accounting for multiple users for a single device (e.g., a family tablet, etc.)).

With that said, by storing the digital ID token in the communication device 108, the digital identity (i.e., the digital ID token) is provisioned to the communication device 108 and whereby the user 110 is permitted to share the digital ID token to one or more relying parties (e.g., the relying party 106, etc.) upon request, for example, to evidence the identity of the user 110. Sharing the digital ID token may be done, by the communication device 108 and/or the user 110, to bind the digital ID token to an existing mobile application, to bind the digital ID token to a newly installed mobile application (e.g., the mobile application 116, etc.), to change the digital ID token, to bind the digital ID token to a website (or webpage) offered by a relying party, etc.

In view of the above, the systems and methods herein provide for provisioning a digital identity (e.g., a digital ID token) to a communication device during a startup of the communication device, where the startup is an initial startup of the communication device “out of the box” or a startup after a factory reset command, or other circumstance where the communication device is returned to a like state. In this manner, the option to provision the digital identity is aligned with the user's expectation to provide data to the communication device in order to “setup” the communication device, thereby reducing friction to the user in provisioning the digital identity. What's more, there is no need to download and/or install any other application to provision the digital identity to the communication device. It should be appreciated, however, that the user may opt to provision the digital identity to the communication device through the native code at a later time, in which the user may still be able to access the processes described herein through a setting in the communication device, whereby, again, the provisioning would still be independent of and/or apart from any other application.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will further be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) as part of a setup procedure for a communication device defined by native code within the communication device, offering, by the communication device, to a user, an option to opt into a digital identity on the communication device; (b) soliciting, by the communication device, the user for an image of a physical document indicative of an identity of the user; (c) capturing, by the communication device, an image of the physical document as presented by the user to an input device of the communication device; (d) compiling and transmitting, by the communication device, an identity packet to an identity verifier, the identity packet including at least the captured image of the physical document, thereby permitting the identity verifier to verify the user based on, at least in part, the captured image of the physical document as included in the identity packet; (e) storing, by the communication device, a digital ID token received in response to the identity packet when at least the captured image of the physical document included in the identity packet is verified, thereby permitting the user to share the digital ID token to one or more relying parties to evidence the identity of the user; (f) soliciting, by the communication device, a biometric from the user; (g) capturing, by the communication device, the biometric as presented by the user to the input device of the communication device; (h) executing the native code, by the communication device, upon a first power up of the communication device by the user or after a factory reset command from the user or other person; (i) performing an integrity check, for the communication device, based on a holding pattern of the communication device by the user of a defined interval and/or based on an authentication profile of the user to the communication device; (j) receiving, by a computing device of an identity provider (IDP), the identity packet from the communication device; (k) transmitting, by the computing device of the IDP, the identity packet to the identity verifier; (l) in response to an assertion from the identity verifier indicating verification, compiling and transmitting, by the computing device of the IDP, the digital ID token to the communication device; (m) verifying, by a computing device of the identity verifier, the captured image of the physical document as included in the identity packet against a user profile for the user including a biometric for the user; and (n) transmitting, by the computing device of the identity verifier, the assertion indicating the verification of the user to the computing device of the IDP.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing a digital identity for a user, the method comprising:
as part of a setup procedure for a communication device defined by native code within the communication device, offering, by the communication device, to a user, an option to opt into a digital identity on the communication device;
soliciting, by the communication device, the user for an image of a physical document indicative of an identity of the user;
capturing, by the communication device, an image of the physical document as presented by the user to an input device of the communication device;
compiling and transmitting, by the communication device, an identity packet to an identity verifier, the identity packet including at least the captured image of the physical document, thereby permitting the identity verifier to verify the user based on, at least in part, the captured image of the physical document as included in the identity packet; and
storing, by the communication device, a digital ID token received in response to the identity packet when at least the captured image of the physical document included in the identity packet is verified, thereby permitting the user to share the digital ID token to one or more relying parties to evidence the identity of the user.

2. The method of claim 1, further comprising:
soliciting, by the communication device, a biometric from the user; and
capturing, by the communication device, the biometric as presented by the user to the input device of the communication device;
wherein the identity packet further includes the captured biometric along with the captured image of the physical document, thereby permitting the identity verifier to further verify the user based on the captured biometric.

3. The method of claim 2, wherein the identity packet further includes a name of the user, a device ID for the communication device, and/or at least one attribute of the user.

4. The method of claim 2, wherein the digital ID token includes the captured biometric, biometric data included in the captured image of the physical document, the image of the physical document, and a device ID for the communication device.

5. The method of claim 2, wherein the digital ID token includes a template of the captured biometric and/or a biometric included in the captured image of the physical document.

6. The method of claim 2, wherein the captured biometric includes at least one of a fingerprint, a face, and/or an iris of the user.

7. The method of claim 1, wherein the physical document includes a government issued ID, which includes biometric data of the user; and/or
wherein the physical document includes at least one of a driver's license and a passport.

8. The method of claim 1, wherein transmitting the identity packet to the identity verifier includes transmitting the identity packet to the identity verifier via an identity provider (IDP); and
wherein the method further comprises receiving the digital ID token from the IDP.

9. The method of claim 1, further comprising receiving, by the communication device, the digital ID token from the identity verifier.

10. The method of claim 1, wherein the communication device includes a portable communication device; and
wherein the input device includes a camera input device.

11. The method of claim 1, further comprising executing the native code, by the communication device, upon a first power up of the communication device by the user or after a factory reset command from the user or other person.

12. The method of claim 11, further comprising performing an integrity check, for the communication device, based on a holding pattern of the communication device by the user of a defined interval and/or based on an authentication profile of the user to the communication device.

13. The method of claim 1, further comprising:
receiving, by a computing device of an identity provider (IDP), the identity packet from the communication device;
transmitting, by the computing device of the IDP, the identity packet to the identity verifier; and
in response to an assertion from the identity verifier indicating verification, compiling and transmitting, by the computing device of the IDP, the digital ID token to the communication device.

14. The method of claim 13, further comprising:
verifying, by a computing device of the identity verifier, the captured image of the physical document as included in the identity packet against a user profile for the user including a biometric for the user; and
transmitting, by the computing device of the identity verifier, the assertion indicating the verification of the user to the computing device of the IDP.

15. A non-transitory computer-readable storage media including executable instructions for providing a digital identity for a user in a communication device, through a setup procedure for the communication device, which when executed by at least one processor, cause the at least one processor to:
as part of the setup procedure for the communication device defined by native code within the communication device, offer the user an option to opt into a digital identity on the communication device;
solicit the user for an image of a physical document indicative of an identity of the user;
capture an image of the physical document as presented by the user to an input device of the communication device;
compile and transmit an identity packet to an identity verifier, the identity packet including at least the captured image of the physical document, thereby permitting the identity verifier to verify the user based on, at least in part, the captured image of the physical document as included in the identity packet; and
store a digital ID token received in response to the identity packet when at least the captured image of the physical document included in the identity packet is verified, thereby permitting the user to share the digital ID token to one or more relying parties to evidence the identity of the user.

16. The non-transitory computer-readable storage media of claim 15, wherein the executable instructions, when executed by the at least one processor, further cause the at least one processor to:
solicit a biometric from the user; and
capture the biometric as presented by the user to an input device of the communication device;
wherein the identity packet further includes the captured biometric along with the captured image of the physical document, thereby permitting the identity verifier to further verify the user based on the captured biometric.

17. The non-transitory computer-readable storage media of claim 16, wherein the digital ID token includes a template of the captured biometric and/or a biometric included in the captured image of the physical document.

18. The non-transitory computer-readable storage media of claim 15, wherein the executable instructions, when executed by the at least one processor in connection with transmitting the identity packet to the identity verifier, cause the at last one processor to transmit the identity packet to the identity verifier via an identity provider (IDP); and
wherein the executable instructions, when executed by the at least one processor, further cause the at least one processor to receive the digital ID token from the IDP.

19. A portable communication device including non-transitory computer executable native code, which configures the portable communication device to facilitate storing a digital ID token for a user in memory of the portable communication device, as part of a setup procedure of the portable communication device indicative of an initial startup of the portable communication device by the user and/or a startup after a factory reset of the portable communication device, whereby the digital ID token is provisioned to the portable communication device in dependence of and/or apart from any application downloaded to the communication device after the setup procedure.
